(19) United States
(12) Patent Application Publication
(10) Pub. No.: US 2004/0133917 A1
(43) Pub. Date: Jul. 8, 2004

(54) Video on demand using MCMD and TDM or FDM

(76) Inventor: Donald L. Schilling, Palm Beach Gardens, FL (US)

Correspondence Address: JOHN GABRYSIAK, ORLOVSKY, MOODY, SCHAAFF & GABRYSIAK, 187 HIGHWAY 36, WEST LONG BRANCH, NJ, 07764, US

(21) Appl. No.: 10/337,555

(22) Filed: Jan. 7, 2003

(51) Int. Cl. H04N 7/173

(52) U.S. Cl. 725/95; 725/98

(57) ABSTRACT

An improvement for television and Internet channel distribution. A plurality of P programs are to be sent over the communications medium, using the multiplicity of channels. Each program has digitized-compressed content. For each program, a set of packets is generated and modulated in a form suitable for transmission over a multiplicity of channels. The packets are interleaved, depending on priority, and then sent over the multiplicity of channels. Assuming equal priority, a first set of packets of the P programs is sent, a second set of packets from the P programs is next sent, and a third set of packets from the P programs is then sent, over the multiplicity of channels. Each set of packets of the first program, the second program, and the third program, is received at a first, second and third set top box, respectively. Display of the first, second and third program is initiated upon receipt of the first, second, second and third set of packets of the first, second and third program, respectively.

### BACKGROUND OF THE INVENTION

This invention relates to cable and satellite distributed television, telephone, and Internet signals, and more particularly to reducing time for viewing a video on demand or other program, when downloading from a head-end or other source.

### DESCRIPTION OF THE RELEVANT ART

Cable and satellites serve as a medium for sending television (TV), telephone, and Internet signals to users in a community. The TV signals typically are sent to a head-end and then distributed throughout the community. All TV programs, each sent as a separate signal, are sent to each house, apartment, etc. The user selects which program to view, by selecting the appropriate channel. If 200 channels were used, for example, each with a symbol rate of one mega-symbols per second (Msymbols/sec), then a total symbol rate of 200 Msymbols/sec must be accommodated along the transmission path from the head-end to each user, even when no user is using the system.

The video signal is an analog signal, which, in the U.S.A., uses a 6 MHz channel bandwidth in order to be transmitted without noticeably distorting the signal. In order to effectively reduce this bandwidth, the signal first is digitized and compressed using an algorithm known as MPEG2. MPEG2 causes the data rate of the resulting signal to be reduced by a factor of two. Using MPEG2, the video signal is transmitted at a data rate of 3 Mbits/s, and requires a 3 MHz bandwidth. Random errors can occur during transmission through the cable, and to correct these errors a Forward Error Correction (FEC) code is employed. Current industrial practice is to use a rate-3/4 code, which increases the date rate to 4 MBits/s, and a bandwidth of 4 MHz. The digital signal is modulated onto a carrier, typically using 256 Quadrature Amplitude Modulation (256-QAM), which reduces the required bandwidth by a factor of 8, to 0.5 MHz. Since the individual channel bandwidth in a cable operated system is 6 MHz, 12 digital video signals can share the same bandwidth as one analog channel. Using MPEG4, which yields a compression of 4, would result in 24 channels being sent in the 6 MHz bandwidth. It is clear that changing the coding or the modulation would also change the number of TV channels that could be sent in a 6 MHz bandwidth.

A typical digital cable system has about 50 analog channels, which include the local TV stations. The remaining channels have been digitized and compressed, as previously discussed. HBO, STARZ, PPV, are some examples of companies that send digitized signals and thereby put 12 programs on a channel that normally contains a single analog program.

The bandwidth of a typical cable system can exceed 750 MHz. Assuming the use of 50 analog channels, which require a total bandwidth of 300 MHz, an additional bandwidth of 450 MHz is available. Since the compressed digital signal requires a bandwidth of 0.5 MHz, potentially an additional 900 programs may be simultaneously transmitted.

In the future, all TV programs will be digitized, resulting in about 1500-3000 (using MPEG4), programs being simultaneously transmitted. These include the channels set aside for Internet access and for telephone use.

Typically, in a community, not all of the channels on a cable system are being viewed at the same time.

The above discussion describes video streaming, which is the transmission of a program in real time. For video on demand (VOD) applications, to accommodate the customer who wants video, or other content, when the customer wants a selected content, the signal should be bursted to the customer and stored in the customer's set top box (STB). A preferred VOD system would send the requested signal in as little time as possible, so that other customers would not have to wait in a queue to receive their selected program. This immediacy of response is the key to a successful VOD program and also to successful use of the cable system for TV, telephone and computer use. As previously shown, the data rate of a digital video signal can be reduced by a total factor of 12, and with MPEG-4 by a factor of 24. Thus, a single video signal can be bursted over a 6 MHz channel in 1/12 or 1/24 of the normal time, respectively, to transmit the program. Thus, a 120 minute video can be bursted, in five or ten minutes, over the 6 MHz channel.

### SUMMARY OF THE INVENTION

A general object of the invention is to download a video on demand (VOD) signal, for viewing at a user's receiver, without delay, to initiate viewing at the user's receiver.

A further object of the invention is to make viewing available of requested VOD signals, telephone communications and Internet access, almost immediately at a user's receiver.

According to the present invention, as embodied and broadly described herein, an improvement to a communications distribution system is provided. A communications distribution system has a multiplicity of Kᵢ channels. Kᵢ is a number of available channels, and the index i refers to a particular number of Kᵢ channels, since the number of channels in the multiplicity of Kᵢ may vary with time. A communications channel typically is cable. The term channel typically refers to a frequency for transmitting a signal, such as a packet, over the communications medium. The communications medium may be cable, wire, or wireless radio. The wireless radio may employ spread-spectrum modulation, as proposed in 3G and future systems, or satellite systems.

A plurality of P programs are to be sent over the communications medium, using the multiplicity of Kᵢ channels. P is a number of programs. P can also vary with time, since the number of requested programs depends in large measure on the time of day. Each program has digitized-compressed content with B_{Tj} bits per program. B_{Tj} is a number of bits and the index value of j refers to a particular program Pⱼ in the plurality of P programs.

For each program Pⱼ in the plurality of P programs, a set of NⱼKᵢ packets are generated. Nⱼ, for a particular program Pⱼ in the plurality of P programs, is a number of packets per channel in the multiplicity of Kᵢ channels. For different values of j, Nⱼ may be, and typically is, different for different programs Pⱼ in the plurality of P programs. Nⱼ may be identical for all programs in the plurality of P programs.

Each packet is modulated in a form suitable for transmission over the multiplicity of K channels. The modulation may be quadrature amplitude modulation (QAM), but other modulation formats may be used. Preferably, each packet has the same number of bits, although packets with different numbers of bits, or varying numbers of bits, may be used. A first set of Kᵢ packets of a first program P₁ in the plurality of P programs are sent over the multiplicity of Kᵢ channels, respectively. A second set of Kᵢ packets of a second program P₂ in the plurality of P programs are then sent over the multiplicity of Kᵢ channels, respectively. A third set of K packets of a third program P₃ in the plurality of P programs are next sent over the multiplicity of Kᵢ channels, respectively. A set of Kᵢ packets of the first program P₁ in the plurality of P programs, a set of Kᵢ packets of a second program P₂ in the plurality of P programs, and a set of Kᵢ packets of a third program P₃ in the plurality of P programs, are continued to be sent over the multiplicity of Kᵢ channels, respectively.

From the multiplicity of Kᵢ channels, each set of Kᵢ packets of the first program P₁ is received at a first set top box intending to receive the first program. Display of the first program P₁ is initiated upon receipt of the first set of Kᵢ packets of the first program P₁.

From the multiplicity of Kᵢ channels, each set of Kᵢ packets of the second program P₂ is received at a second set top box intending to receive the second program. Display of the second program P₂ is initiated upon receipt of the first set of Kᵢ packets of the second program P₂;

Similarly, from the multiplicity of Kᵢ channels, each set of Kᵢ packets of the third program P₃ is received at a third set top box intending to receive the third program. Display of the third program P₃ is initiated upon receipt of the third set of Kᵢ packets of the third program P₃.

Also, the interleaving of the packets may depend on the programs priority. Thus, voice traffic should not be delayed and given higher priority than a video signal.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 is a block diagram of a headend connected through a communications channel to a number of control boxes and remote-subscriber units;

FIG. 2 is a block diagram illustrating a headend controller;

FIG. 3 illustrates a packet from a control box;

FIG. 4 is a block diagram of a control box interfacing a remote-subscriber unit;

FIG. 5 illustrates a packet for the Internet;

FIG. 6 is a diagram for interfacing the control box of a remote-subscriber unit to the Internet;

FIG. 7 is a functional block diagram at the headend;

FIG. 8 is a functional block diagram at a remote-subscriber unit;

FIG. 9 illustrates a packet with channel information sent from the headend controller to a particular remote-subscriber unit;

FIG. 10 is a functional block diagram of the headend;

FIG. 11 is a system block diagram illustrating compression/modulation of a digital video signal;

FIG. 12 illustrates streaming P programs using compression and FDM, delay, with P(R/C) less than or equal to R_{c};

FIG. 13 illustrates streaming P programs using compression and TDM, delay, with P(R/C) less than or equal to R_{c};

FIG. 14 illustrates a multiplicity of channels and TDM packets;

FIG. 15 illustrates bursting P programs using compression, MCMD, and TDM, delay, with P(R/CK) less than or equal to R_{c};

FIG. 16 illustrates bursting P programs using compression, MCMD, and FDM, delay, with P(R/CK) less than or equal to R_{c}; and

FIG. 17 is a block diagram illustrating the bursting process.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

The present invention provides a new approach to downloading digitized content, as used in video-on-demand (VOD), Telephone, TV, or Internet systems.

The present invention may include a system of delivering only those TV channels requested by at least one remote-subscriber unit, eliminating the necessity of broadcasting all TV channels to all remote-subscriber units at the same time.

The present invention may include the simultaneous reception/transmission of TV, VOD, Internet and Telephone signals.

Variable Data Rate Video System

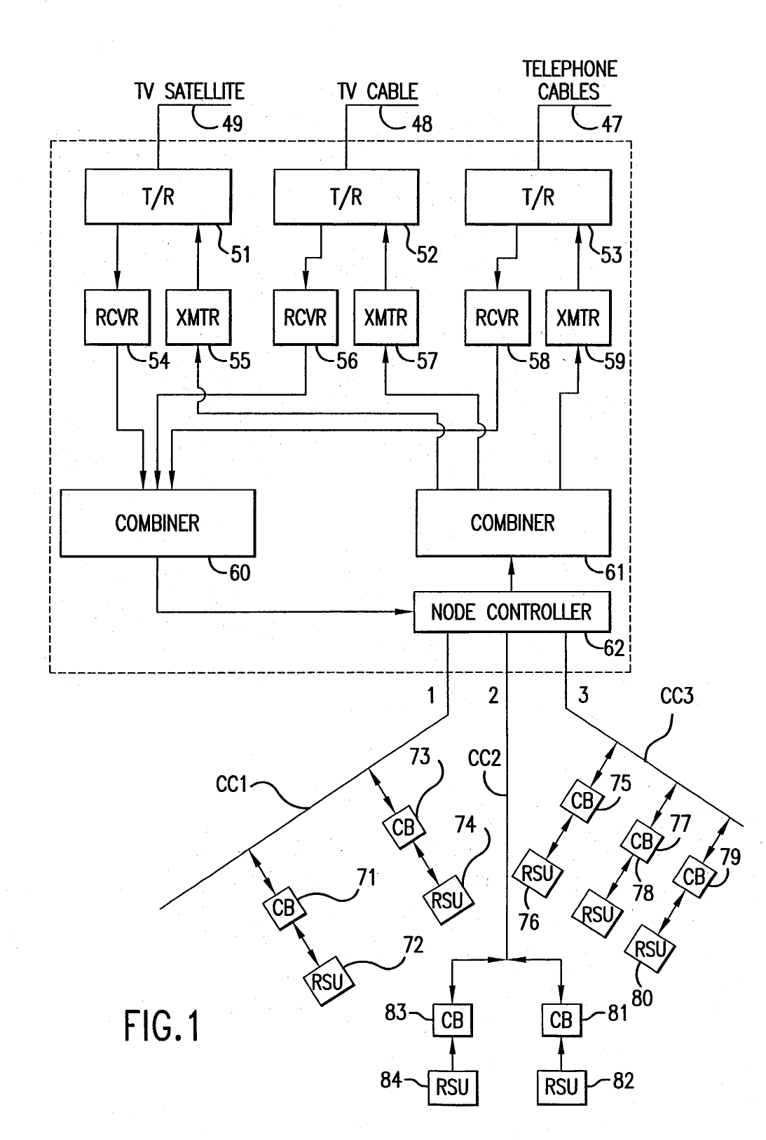

As illustratively shown in FIG. 1, a television channel distribution system is provided comprising a headend 50, a plurality of remote-subscriber units (RSUs) 72, 74, 76, 78, 80, 82, 84, a communications channel 39, and a plurality of control boxes 71, 73, 75, 77, 79, 81, 83. The headend 50 has a plurality of content signals available for distribution. The content signals may be video-on-demand content signals, Internet content signals, or other content signals. The term “content signal”, as used herein, refers to any of the possible content signals, such as VOD content signal, Internet content signals, or other content signal. The content signals may arrive from different sources, such as satellite 49, TV cable 48, telephone cable 47, or may be stored within the system, such as on CD ROM, disk, or other storage media. N represents the total number of content signals available in the plurality of content signals. K represents the total number of remote-subscriber units in the plurality of remote scriber units 72, 74, 76, 78, 80, 82, 84. The communications channel 39, which connects the node controller 62 to each of the control boxes 71, 73, 75, 77, 79, 81, 83 may be from cable, twisted pair, fiber optics medium, or wireless path using radio waves.

The headend 50 includes, for each external source, a receiver, transmitter, and transmit-receive (T/R) switch. The transmitter and receiver equivalently may be embodied as a transceiver. The transmitter transmits signals to the external source, and the receiver receives signals from the external source. The T/R switch, in each case, allows transmitting signals to be received from each external source.

In the exemplary arrangement of FIG. 1, by way of example, for satellite signals, a T/R switch 51 is coupled to the satellite ground antenna 49, and to a receiver 54 and transmitter 55. The receiver 54 receives signals from the satellite, and the transmitter 55 transmits signals to the satellite, using the T/R switch 51 and satellite ground antenna 49, as is well known in the art. For TV cable, a T/R switch 52 is coupled to the TV cable system 48 and to a receiver 56 and a transmitter 57. The receiver 56 receives signals from the TV cable 48, and the transmitter 57 transmits signals to the TV cable 48, using the T/R switch 52, as is well known in the art. For telephone cable, or twisted pair signals, a T/R switch 53 is coupled to the telephone cable 47 and to a receiver 58 and a transmitter 59. The receiver 58 receives signals from the telephone cable 47, and the transmitter 59 transmits signals to the telephone cable 47, using the T/R switch 53, as is well known in the art.

Each receiver 54, 56, 58 is coupled to a receiver combiner 60, for combining signals from each receiver for transmission and distribution through the node controller 62, over a communications channel 39. Each transmitter 55, 57, 59 is coupled to a combiner 61 for combining signals from the communications channel 39 for transmission over the respective external source.

Node controller 62 is employed to separate the programs sent along the communications channels CC1, CC2, CC3, etc. Thus, a program requested by remote-subscriber unit 72, for example, will be sent along communications channel CC1 and not along communications channel CC2 or CC3. The node controller 62 also can be used to limit the number of remote-subscriber units, connected through a respective node, to be less than the number of channels available. Thus, if there are 250 channels, by way of example, then the node controller 62 may limit the number of remote-subscriber units connected to the respective node controller 62 to 240 remote-subscribers units. By having the node controller 62 limit the number of remote-subscriber units connected through a respective node to less than the total number of channels available at the node, ensures that some non-used channels are available.

Assume that 250 channels are available, by way of example, and if there are 240 users attached to each node, then there always are 10 unused channels. The frequency associated with the unused channels will change from time-to-tome as the users, remote-subscriber units, attached to each node change the channels viewed.

The plurality of remote-subscriber units (RSUs) 72, 74, 76, 78, 80, 82, 84, may be televisions, computers, telephones, or other devices for interaction with signals from the headend 50. The plurality of remote-subscriber units (RSUs) 72, 74, 76, 78, 80, 82, 84, is coupled to the communications channel 39 through the plurality of control boxes 71, 73, 75, 77, 79, 81, 83.

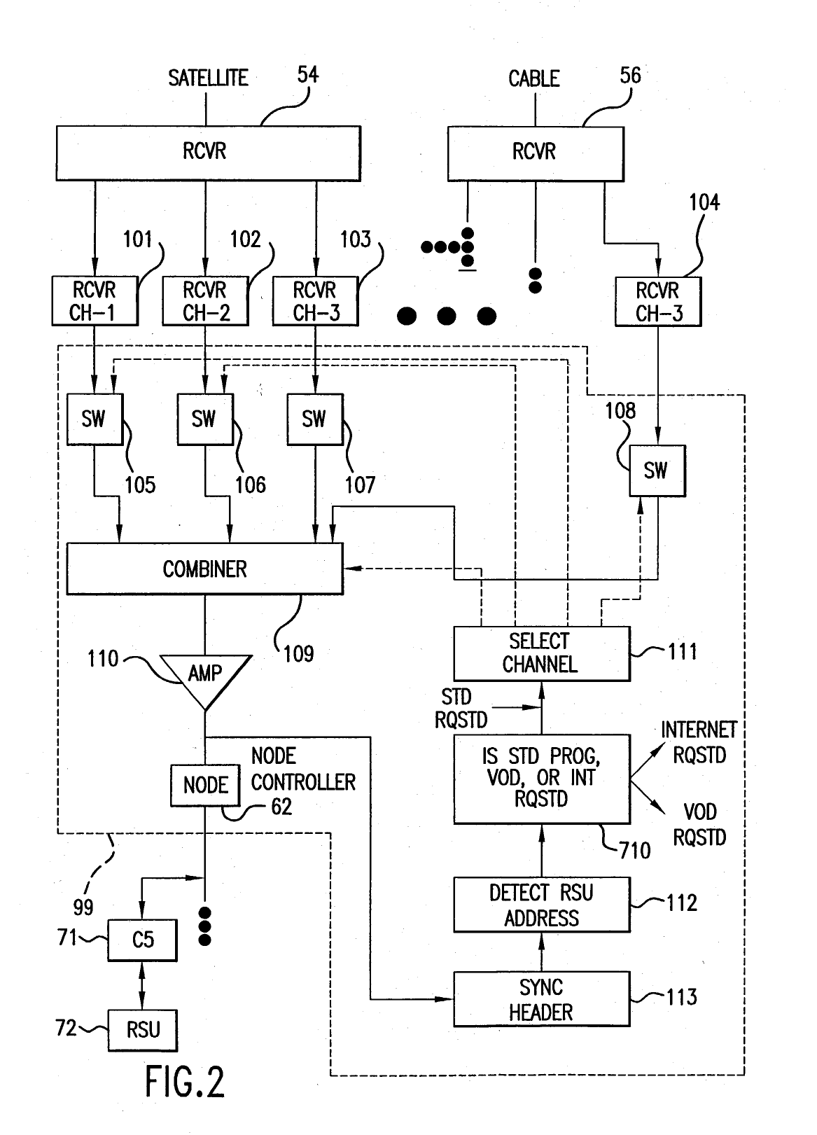

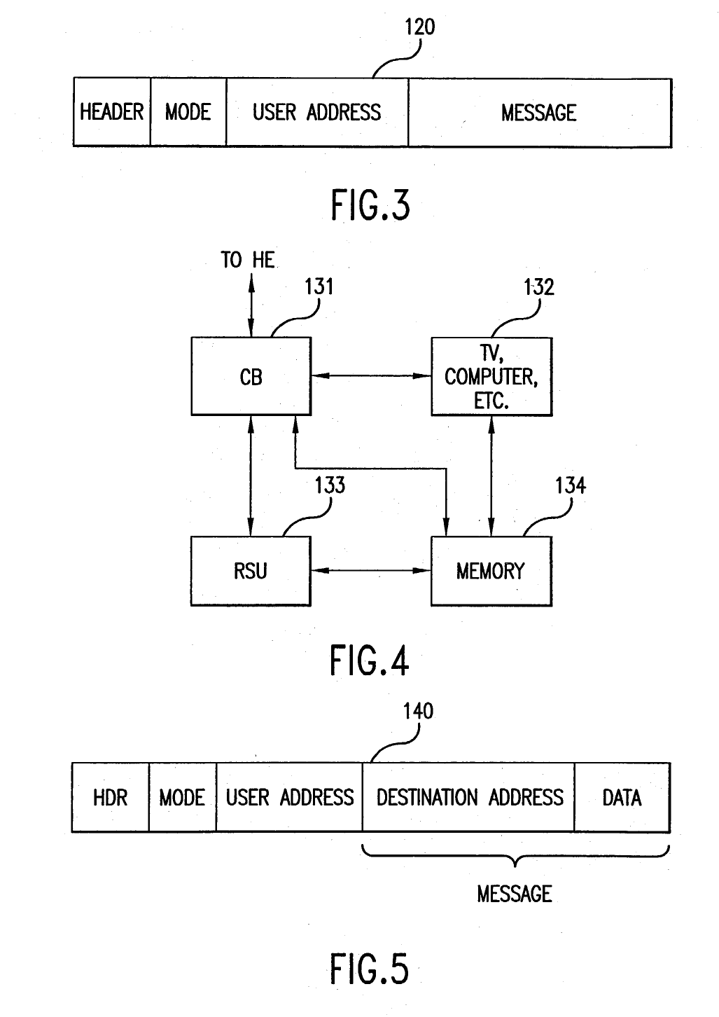

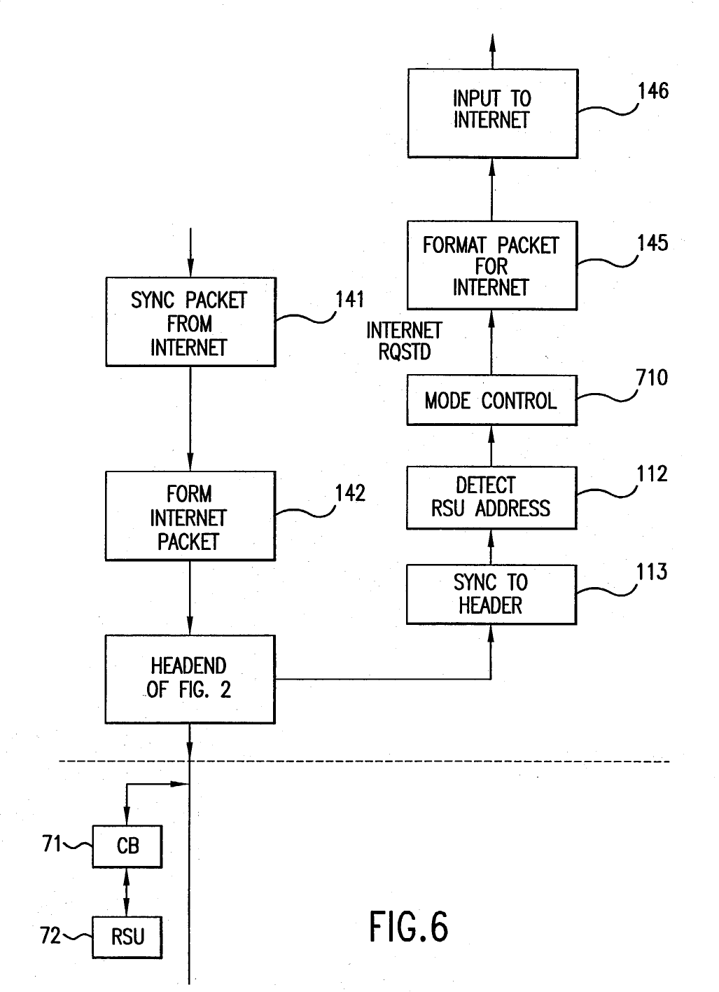

In FIG. 2, A headend controller 99 is added to FIG. 1. The headend controller 99 includes header synchronizer 113, user address detector 112, mode selectors 710, channel selector 111, and a plurality of electronic switches 105, 106, 107, 108. The plurality of electronic switches 105, 106, 107, 108 may be embodied as a plurality of gates. Each receiver of FIG. 1, may have a plurality of receiver channels at an output. Thus, for receiver 54 and receiver 56, a plurality of content signals CH-1, Ch-2, CH-3, . . . , Ch-N, is available from a plurality of sub-receiver units 101, 102, 103, 104. The plurality of electronic switches 105, 106, 107, 108 control which of the plurality of content signals is available at receiver combiner 109.

The plurality of control boxes 71, 73, 75, 77, 79, 81, 83 is connected to the plurality of remote-subscriber units 72, 74, 76, 78, 80, 82, 84, respectively. The plurality of control boxes 71, 73, 75, 77, 79, 81, 83 sends a plurality of control signals, respectively, to the headend 50. Each control box is connected to the headend 50 and through the communications channels 39, and the node controller 62, and to a respective remote-subscriber unit of the plurality of remote-subscriber units 72, 74, 76, 78, 80, 82, 84. Each control box sends a control signal through the communications channel 39 to the headend 50 for requesting a particular TV signal of the plurality of TV signals CH-1, Ch-2, CH-3, Ch-N, or for requesting the special content signals: VOD programming, or Internet communications.

The headend controller 99, in response to the plurality of control signals from the plurality of control boxes 71, 73, 75, 77, 79, 81, 83, selects a plurality of content signals CH-1, CH-2, CH-3, . . . , CH-N, for distribution through the communications channel 39 to the plurality of remote-subscriber units 72, 74, 76, 78, 80, 82, 84. More particularly, the headend controller 99 is coupled to the communications channel 39. The headend controller 99 receives the plurality of control signals from the plurality of control boxes 71, 73, 75, 77, 79, 81, 83. In addition, the mode control 710 in the headend controller 99 may be requested to select one of a plurality of available VOD programs or Internet address which will be downloaded using the “borrowed” channels.

A representative control signal 120 is shown in FIG. 3. The control signal 120 typically includes a header, mode indicator, user address and message. For requesting a standard TV program, the mode indicates “STD TV” and the message indicates the “DESIRED CHANNEL”. The control signal 120 originates at a control box of the plurality of control boxes 71, 73, 75, 77, 79, 81, 83. The header of the control signal 120 is used for synchronization by header synchronizer 113. The user address detector 112 detects the user address in the control signal 120. The user address is a unique address assigned to each control box in the plurality of control boxes 71, 73, 75, 77, 79, 81, 83. By detecting the user address, the headend controller 99 knows from which remote-subscriber unit a particular control signal originated. This tells the node controller 62 over which node to send the requested programming. The mode control 710 indicates whether a standard TV channel or a VOD, or Internet, content signal is desired. If the standard TV channel is desired, then the channel selector 111 reads which TV channel is being selected by a particular remote-subscriber unit. In response to the information from the channel selector, a particular electronic switch from the plurality of electronic switches 105, 106, 107, 108 is activated to let the selected TV signal pass to the receiver combiner 60, for transmission and distribution to the respective remote-subscriber unit. The header synchronizer 113, user address detector 112, mode control 710 channel selector 111, and plurality of electronic switches 105, 106, 106, 108 may be embodied as discrete electronic circuits, embedded in or part of an application integrated circuit (ASIC), software controlling gate array logic, firmware or other electronic and/or software, as is well know in the art, for implementing such detectors and controllers. This is for standard programming, wherein a single program gets a single channel. For VOD programming, or Internet access, content programs, a single program uses all “borrowed” channels simultaneously.

FIG. 4 is a block diagram of a control box 131 interfacing a remote-subscriber unit 133 with a memory 134 for storing information at the remote-subscriber unit 133. The memory 134 can store a VOD or Internet content signal, downloaded from the headend 50. The control box 131 might interface a television, computer, etc. located at the remote-subscriber unit 133. The remote-subscriber unit 133 informs the control box 131 as to which content signal, such as VOD program or Internet access, the remote-subscriber unit 133 wants to receive. The control box 131 sends the control signal along the communications channel 39 to the headend 50, telling the headend to send the particular content signal, such as VOD program or Internet access. TV channels, for example, simultaneously are inputted to the control box from the headend. The control box is tuned to receive the requested TV frequency channel and it is detected and forwarded to the TV for viewing. For VOD programming or Internet access, the control box is tuned to receive the borrowed channels, each T seconds.

For computer operation, the remote-subscriber unit 133 might be a keyboard, or touch screen, which is connected to the hard drive 134 and monitor 132. For Internet operation the remote-subscriber unit 133 accesses the control box 131 and sends from the control box 131 packets along the communications channel 39 to the headend 50.

FIG. 5 illustrates a typical packet which might be used for accessing the Internet. The packet of FIG. 5 includes a header for synchronization, a “mode” indicator to select standard TV, VOD or Internet access, a user address which indicates the originator of the packet, and a “message” portion which, for Internet access, includes a destination address and data. FIGS. 3 and 5 are similar, each containing the header, mode, user address and message. When a VOD program is selected by the “mode” portion, then the message indicates which particular VOD program is requested.

FIG. 6 is a block diagram for interfacing a remote-subscriber unit 72 through a control box 71 along a communications channel 39 to the headend and then to the Internet from ports 47, 48 or 49 of FIG. 1. Signals or messages from the Internet arrive in packets. The header of the packet provides synchronization 141, then an Internet selector code is inserted. Messages or signals traveling to the Internet provide synchronization from the header 113, the Remote-Subscriber Unit's address is determined 112, and that Internet access is requested 710. Then the message is detected for the Internet 710 from the Internet Selector portion of the packet. The packet is then formatted 145 for the Internet, and inputted 146 to the Internet.

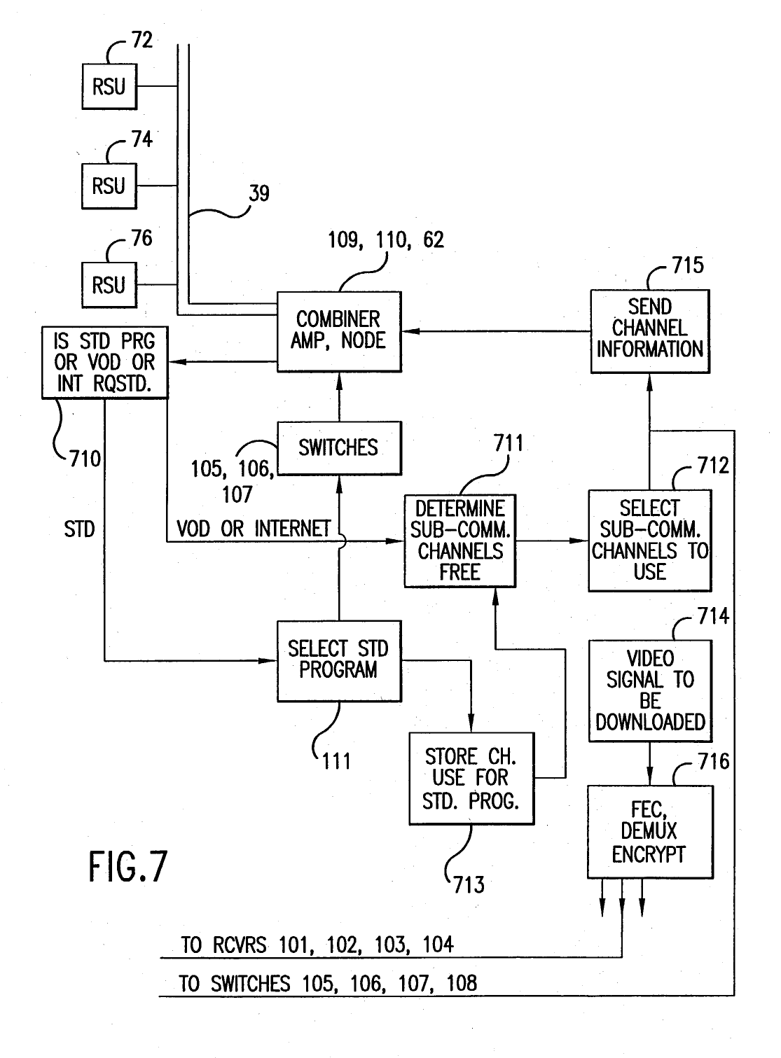

The headend (HE) controller is coupled to the communications channel 39. The headend controller 99 receives the plurality of control signals from the plurality of remote-subscriber units 72, 74, 76, 78, 80, 82, 84. In FIG. 7, in response to a particular control signal, the headend controller 99 determines 710 if regular programming or VOD programming or Internet access is requested. If VOD programming or Internet access is requested, then the headend controller determines 711 which sub-communications channels are being used, and therefore which channels can be borrowed from the total number of sub-communications channels. From the free or available sub-communications channels, the headend controller 99 selects 712, within a first time period, a first multiplicity of sub-communications channels from the plurality of sub-communications channels.

The first multiplicity of sub-communications channels are, at time of selection, currently available, within the first time period, for transmission through the communications channel 39 to a particular remote-subscriber unit. M1 represents a number of the first multiplicity of sub-communications channels within the communications channel. M1 is less than L. The headend controller 99 sends or transmits 715, to the particular remote-subscriber unit, first channel information indicating which channels from the plurality of communications channels are the first multiplicity of sub-communications channels to be “borrowed” and used for transmitting a first portion of a particular VOD or Internet content signal 714 from the headend to the remote-subscriber unit.

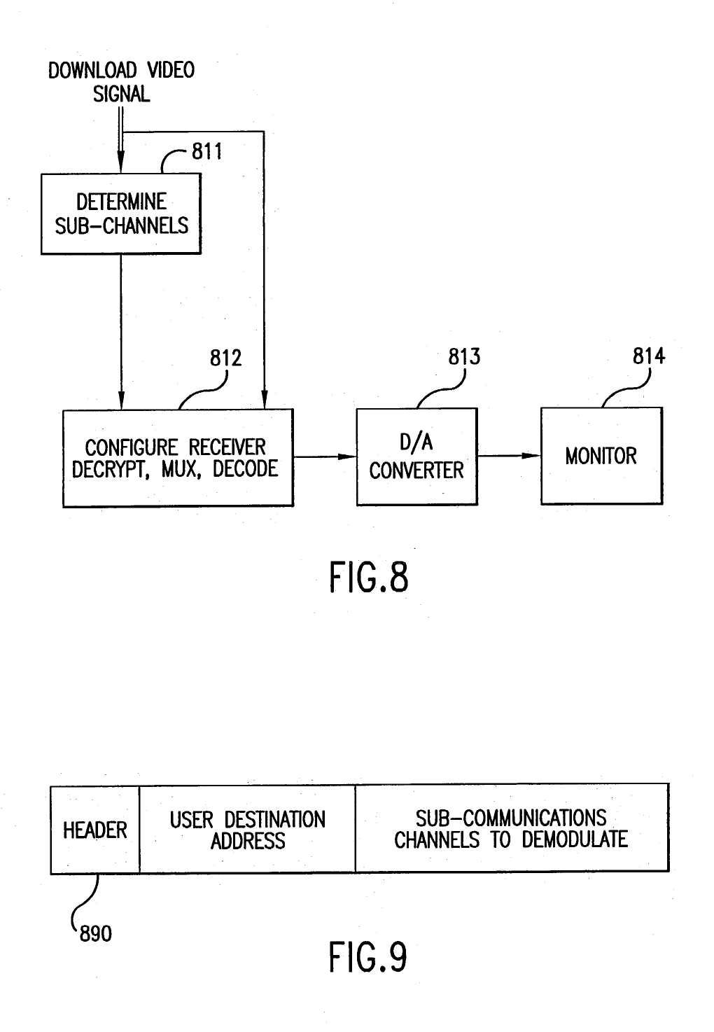

The particular remote-subscriber unit receives 811 of FIG. 8, the first channel information from the headend 99. In response to the first channel information, the particular remote-subscriber unit sets 812 receiver means, typically a plurality of receivers, for receiving the first multiplicity of sub-communications channels from the headend 99. The receiver means typically would include sufficient receiver for receiving the first multiplicity, and possibly the entire plurality, of sub-communications channels.

The headend 99 FEC encodes, demultiplexes, and optionally encrypts, and then packetizes 716 the particular VOD or Internet content signal 714 into M1 data streams, and sends the M1 data streams over the first multiplicity of sub-communications channels to the particular remote-subscriber unit. The remote-subscriber unit receives the M1 data streams from the first multiplicity of sub-communications channels, and depacketizes, if required, decrypts, multiplexes and FEC decodes the M1 data streams for reassembling the first portion of the particular VOD or Internet content signal 714.

The invention readily would extend to sending additional portions of the particular VOD or Internet content signal 714, using different sets or numbers from the plurality of sub-communications channels, for the multiplicity of sub-communications channels. Thus, the headend controller 99 further determines, in a second time period, availability of a second multiplicity of sub-communications channels. The headend controller can determine availabli of the second multiplicity of sub-communications channels by determining 710 which sub-communications channels are being used, and by determining 711 which sub-communications channels are free or available. The second multiplicity of sub-communications channels typically is not equal to the first multiplicity of sub-communications channels, either in number or in sub-channel selection. In response to the particular control signal, the headend controller 99 selects 712 the second multiplicity of sub-communications channels from the plurality of sub-communications channels, available, within the second time period, for transmission through the communications channel to a particular remote-subscriber unit. M2 represents a number of the second multiplicity of sub-communications channels within the communications channel. M2 is less than L. The headend controller 99 sends, to the particular remote-subscriber unit, second channel information indicating which channels from the plurality of communications channels are the second multiplicity of sub-communications channels to be used for transmitting a second portion of the VOD or Internet content signal from the headend to the remote-subscriber unit.

The particular remote-subscriber unit receiving the second channel information from the headend. In response to the second channel information, the particular remote-subscriber unit sets receiver means for receiving the second multiplicity of sub-communications channels from the headend.

The headend demultiplexes a second portion of the particular VOD or Internet content signal 714 into M2 data streams, and sends the M2 data streams over the second multiplicity of sub-communications channels to the particular remote-subscriber unit. The remote-subscriber unit receives the M2 data streams from the second multiplicity of sub-communications channels, and multiplexes the M2 data streams for reassembling the second portion of the particular VOD or Internet content signal 714.

For sending a third portion of the particular VOD or internet content signal 714, the headend controller 99 further determines, in a third time period, availability of a third multiplicity of sub-communications channels. The headend controller 99 can determine available of the third multiplicity of sub-communications channels by determining 710 which sub-communications channels are being used, and by determining 711 which sub-communications channels are free or available. The third multiplicity of sub-communications channels might not be equal to the second multiplicity of sub-communications channels. In response to the particular control signal, the headend controller 99 selects the third multiplicity of sub-communications channels from the plurality of sub-communications channels. The third multiplicity of sub-communications channels are available, within the third time period, for transmission through the communications channel to a particular remote-subscriber unit. M3 represents a number of the third multiplicity of sub-communications channels within the communications channel. M3 is less than L. The headend controller 99 sends, to the particular remote-subscriber unit, third channel information indicating which channels from the plurality of communications channels are the third multiplicity of sub-communications channels to be used for transmitting a third portion of the VOD or Internet content signal from the headend to the remote-subscriber unit.

The particular remote-subscriber unit receives the third channel information from the headend. In response to the third channel information, the particular remote-subscriber unit sets receiver means for receiving the third multiplicity of sub-communications channels from the headend.

The headend demultiplexes a third portion of the particular VOD or Internet content signal 714 into M3 data streams, and sends the M3 data streams over the third multiplicity of sub-communications channels to the particular remote-subscriber unit. The remote-subscriber unit receives the M3 data streams from the third multiplicity of sub-communications channels, and multiplexes the M3 data streams for reassembling the third portion of the particular Video or Internet content signal 714.

For sending a fourth portion of the particular content signal 714, the headend controller 99 further determines, in a fourth preset time period, availability of a fourth multiplicity of sub-communications channels. The headend controller 99 can determine available of the fourth multiplicity of sub-communications channels by determining 710 which sub-communications channels are being used, and by determining 711 which sub-communications channels are free or available. The fourth multiplicity of sub-communications channels is not equal to the third multiplicity of sub-communications channels. In response to the particular control signal, the headend controller 99 selects the fourth multiplicity of sub-communications channels from the plurality of sub-communications channels. The fourth multiplicity of sub-communications channels available, within the fourth time period, for transmission through the communications channel to a particular remote-subscriber unit. M4 represents a number of the fourth multiplicity of sub-communications channels within the communications channel. M4 is less than L. The headend controller 99 sends to the particular remote-subscriber unit, fourth channel information indicating which channels from the plurality of communications channels are the fourth multiplicity of sub-communications channels to be used for transmitting a fourth portion of the VOD or Internet content signal from the headend to the remote-subscriber unit.

The particular remote-subscriber unit receives the fourth channel information from the headend. In response to the fourth channel information, the particular remote-subscriber unit sets receiver means for receiving the fourth multiplicity of sub-communications channels from the headend.

The headend demultiplexes a fourth portion of the particular content signal 714 into M4 data streams, and sends the M4 data streams over the fourth multiplicity of sub-communications channels to the particular remote-subscriber unit. The remote-subscriber unit receives the M4 data streams from the fourth multiplicity of sub-communications channels, and multiplexes the M4 data streams for reassembling the fourth portion of the particular VOD or internet content signal 714.

For sending a fifth portion of the particular VOD or Internet content signal 714, the headend controller 99 further determines, in a fifth time period, availability of a fifth multiplicity of sub-communications channels. The headend controller 99 can determine available of the fifth multiplicity of sub-communications channels by determining 710 which sub-communications channels are being used, and by determining 711 which sub-communications channels are free or available. The fifth multiplicity of sub-communications channels might not be equal to the fourth multiplicity of sub-communications channels. In response to the particular control signal, the headend controller 99 selects the fifth multiplicity of sub-communications channels from the plurality of sub-communications channels, available, within the fifth time period, for transmission through the communications channel to a particular remote-subscriber unit. M5 represents a number of the fifth multiplicity of sub-communications channels within the communications channel. M5 is less than L. The headend controller 99 sends, to the particular remote-subscriber unit, fifth channel information indicating which channels from the plurality of communications channels are the fifth multiplicity of sub-communications channels to be used for transmitting a fifth portion of the VOD or Internet content signal from the headend to the remote-subscriber unit.

The particular remote-subscriber unit receives the fifth channel information from the headend. In response to the fifth channel information, the particular remote subscriber unit sets receiver means for receiving the fifth multiplicity of sub-communications channels from the headend.

The headend demultiplexes a fifth portion of the particular VOD or Internet content signal 714 into M5 data streams, and sends the M5 data streams over the fifth multiplicity of sub-communications channels to the particular remote-subscriber unit. The remote-subscriber unit receives the M5 data streams from the fifth multiplicity of sub-communications channels, and multiplexes the M5 data streams for reassembling the fifth portion of the particular VOD or Internet content signal 714.

The further extension to a sixth portion of the particular VOD or Internet content signal 714, and as would be understood to those skilled in the art, that the invention would extend to an Nth portion of the particular VOD or Internet content signal 714, the headend controller 99, by way of example, further determines, in a sixth time period, availability of a sixth multiplicity of sub-communications channels. The headend controller 99 can determine available channels of the sixth multiplicity of sub-communications channels by determining 710 which sub-communications channels are being used, and by determining 711 which sub-communications channels are free or available. The sixth multiplicity of sub-communications channels might not be equal to the fifth multiplicity of sub-communications channels. In response to the particular control signal, the headend controller 99 selects the sixth multiplicity of sub-communications channels from the plurality of sub-communications channels, available for transmission through the communications channel to a particular remote-subscriber unit. M6 represents a number of the sixth multiplicity of sub-communications channels within the communications channel. M6 is less than L. The headend controller 99 sends, to the particular remote-subscriber unit, sixth channel information indicating which channels from the plurality of communications channels are the sixth multiplicity of sub-communications channels to be used for transmitting a sixth portion of the VOD or Internet content signal from the headend to the remote-subscriber unit.

The particular remote-subscriber unit receives the sixth channel information from the headend. In response to the sixth channel information, the particular remote-subscriber unit sets receiver means for receiving the sixth multiplicity of sub-communications channels from the headend. The headend demultiplexes a sixth portion of the particular VOD or Internet content signal 714 into M6 data streams, and sends the M6 data streams over the sixth multiplicity of sub-communications channels to the particular remote-subscriber unit. The remote-subscriber unit receives the M6 data streams from the sixth multiplicity of sub-communications channels, and multiplexes the M6 data streams for reassembling the sixth portion of the particular VOD or Internet content signal 714.

Since the reassembled VOD or Internet content signal is digital, the digital VOD or Internet content signal, for viewing on an analog televison or monitor, would digital to analog convert 813 the digital VOD or Internet content signal to an analog signal, for viewing on a monitor 814.

The first, second, third, fourth, fifth and sixth channel information, and channel information in general, might be embodied as packets 890, as shown in FIG. 9.

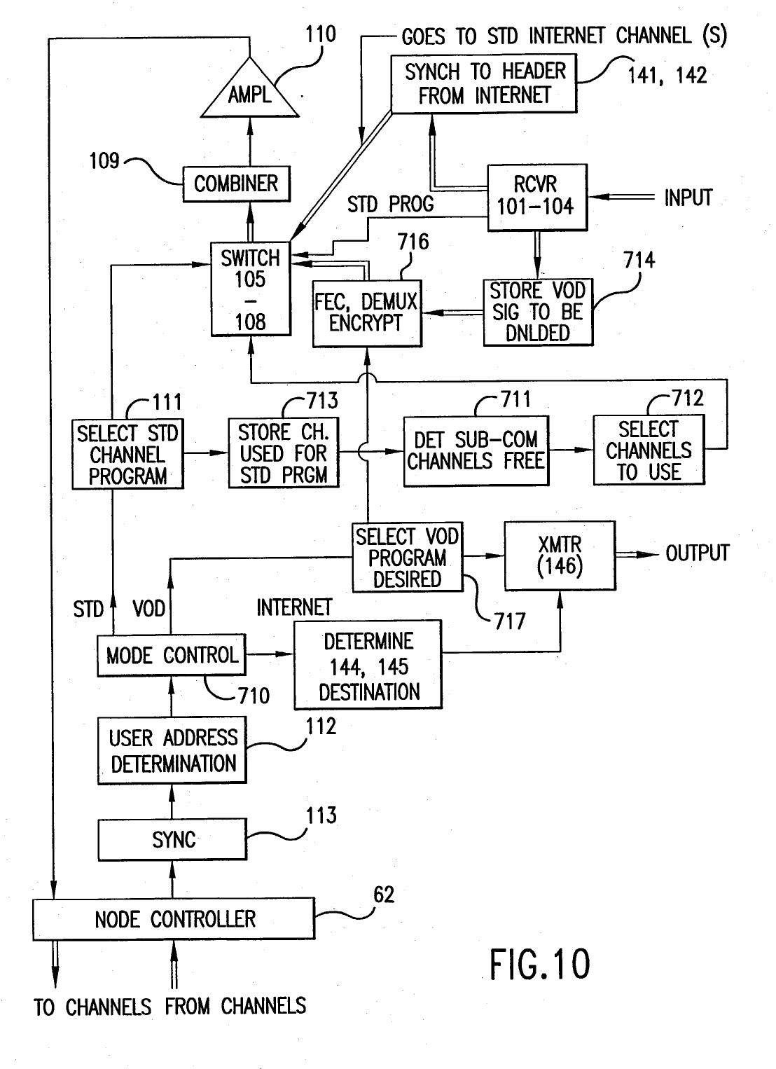

FIG. 10 is a composite drawing of the headend, which helps understand operation and use of the present invention.

Uplink

Signals from the channel 39 enter the node controller 62. The header is synchronized 113, then the remote-subscriber unit's address is read 112, and the mode controller 710 determines whether the user requested standard TV programming, or a special content signal, such a VOD or Internet.

If standard TV were requested, then the packet sent by the user determines what channel is requested 111, and the switches 105, 106, 107, 108 provide the correct receiver output 101-104 to send the requested TV channel to the appropriate remote-subscriber unit. The appropriate TV channel is then sent via the combiner 109, amplifier 110, through the correct channel. Since the particular channel requested now is in use, the particular channel cannot be “borrowed”. This information is stored in memory 713. The system then determines 711 which channels are free and selects 712 the appropriate channels to “borrow” if there is a special content signal to be rapidly downloaded.

If Internet access were requested, then the packet's destination is determined 144-145, and the packet is transmitted 146 to the Internet.

If a VOD program were desired, then the desired program request is selected 717 and sent to the transmitter 146, and forwarded to the content provider.

Downlink

The receiver input contains standard TV signals, and the VOD and Internet, special content signals.

The requested standard TV signals are selected by the switches 105-108, combined with the other signals 109, and sent along the appropriate communications channel through amplifier 110 and node controller 62, to the appropriate remote-subscriber unit.

If a VOD signal were requested, then the VOD signal is stored 714, and then FEC encoded, possibly encrypted, and then demultiplexed 716 into the appropriate number of “borrowed” channels. The resulting signal then is sent to the switches 105-108, combiner 109, amplifier 110 and then sent along the appropriate channel through amplifier 110 and node controller 62 to the appropriate remote-subscriber unit.

When an Internet download arrives at the receivers 101-104, the Internet download is synchronized and the user's address determined. The signal then goes to the switches 105-108, combined 109 with other signals 109, and sent along the appropriate channel through amplifier 110 and node controller 62 to the appropriate remote-subscriber unit.

Video On Demand Using MCMD and TDM and FDM

Content, such as a movie, might have a display time T_{D} of perhaps 120 minutes. For the content, or movie, during the display time, a certain amount of information, I bits, is displayed to the user. The streaming rate Rₛ of the information per minute, is I/T_{d}.

Assume that P programs of content, each having display time T_{D}, by way of example, the display time TD might equal two hours, are to be transmitted over the same channel. Then a queue is formed and the P^{th} content is delayed 2 P hours. Such delay typically is not acceptable. HDTV programs may contain approximately four times more content than standard programs, and therefore, require the use of more than a single channel for transmission, unless compression, which results in a loss of information and hence a loss in quality. MCMD can be employed to reduce this delay time.

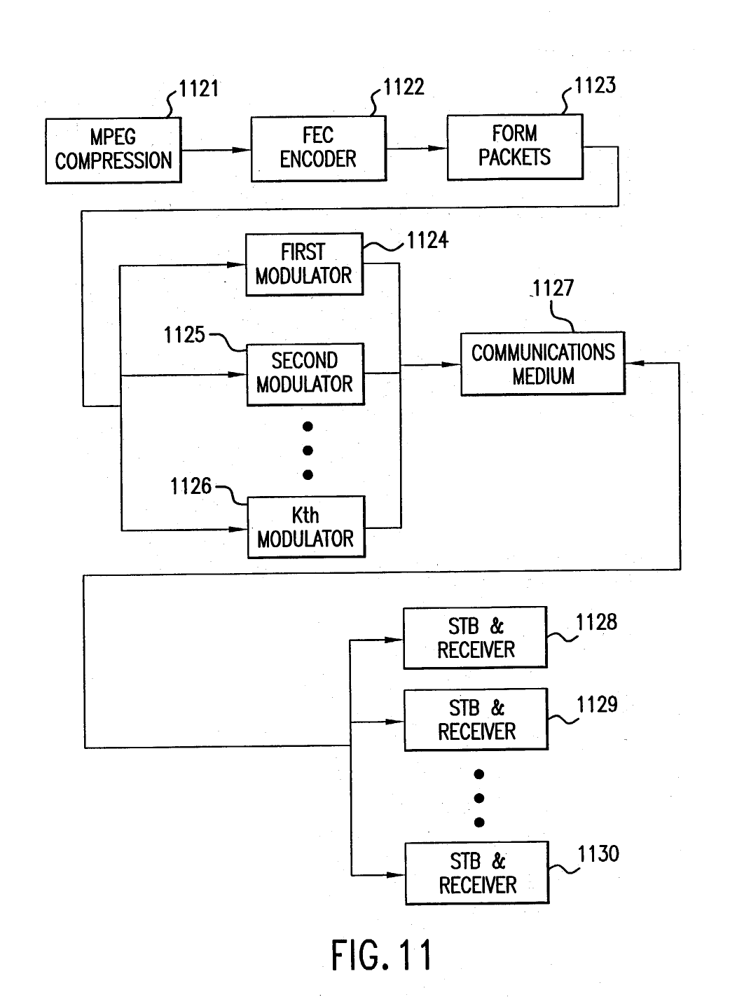

Using compression techniques, such as MPEG compression 1121, with forward error correction encoding 1122, as shown in FIG. 11, and modern modulation techniques, each two hour content can be sent through the same channel, in about five minutes, with a compression factor C of about 12. With this approach, information is considered to have been bursted through the channel. Assuming P programs of content are to be sent, then the P^{th} content is now delayed by P/12 hours or 5P minutes. If P were large, then this delay is not acceptable.

Using MCMD with compression, and assuming the use of 10 channels, a two hour program can be received in 0.5 minutes, instead of five minutes. The delay of the P^{th} program would be 0.5P minutes. If P were large, then this delay may still not be acceptable.

The use of TDM with MCMD can significantly reduce the time delay. Continuing with the foregoing example, first transmit first content C₁ for the time 0.5/P minutes, then transmit second content C₂ for the next 0.5/P minutes, and similarly the third and subsequent content for 0.5/P minutes. After each content interval is transmitted the first time, the sequence of transmitting the first content C₁, for the time 0.5/P minutes, then transmitting second content C₂ for the next 0.5/P minutes, and similarly the third and subsequent content, are repeated. The result is that the last content in the sequence is delayed 0.5 minutes, independent of the number of programs P. The delay is decreased as the number of borrowed channels used for the MCMD process is increased. Thus, if 10 channels were borrowed, then the maximum program delay is only 0.5 minutes.

FDM may be employed within each channel, if the number of programs P were small, and/or the compression factor C is sufficiently large. Consider, for example, that a compression factor of C=12 were employed. Since a single program can be accommodated using a single channel, 12 compressed programs can be accommodated on the same channel. If the number of programs P exceeded 12, then MCMD should be employed since a second channel should be found.

The present invention describes the use of TDM/MCMD to decrease user program delay.

The improvement to a television channel distribution system, as illustrative shown in FIG. 11, has a multiplicity of Kᵢ channels for delivering a plurality of P programs. Kᵢ is a number of available channels and an index i refers to a particular number of Kᵢ channels. P is a number of programs. Each program has digitized-compressed content, from, for example, MPEG compression 1121, with B_{Tj} bits per program, and forward error correction (FEC) encoding 1122. B_{Tj} is a number of bits and an index value of j refers to a particular program Pⱼ in the plurality of P programs. For each program Pⱼ in the plurality of P programs, packeting means, illustrated as subsystem to from packets 1123, generates a set of NⱼKᵢ packets. Nⱼ, for a particular program Pⱼ in the plurality of P programs, is a number of packets per channel in the multiplicity of Kᵢ channels. Modulator means modulates each packet in a form suitable for transmission over the multiplicity of Kᵢ channels, respectively. Modulator means is illustrated in FIG. 11 as a plurality of modulators 1124, 1125, 1126, but equivalently could be one modulator shared by each channel. The first modulator 1124 sends a first set of Kᵢ packets of a first program P₁ in the plurality of P programs over the multiplicity of Kᵢ channels, respectively. The second modulator 1125 sends a second set of Kᵢ packets of a second program P₂ in the plurality of P programs over the multiplicity of Kᵢ channels, respectively. The third modulator 1126 sends a third set of Kᵢ packets of a third program P₃ in the plurality of P programs over the multiplicity of Kᵢ channels, respectively.

The first modulator 1124 continues to send, in sequence, a set of Kᵢ packets of the first program P₁ in the plurality of P programs over the multiplicity of Kᵢ channels, respectively. The second modulators 1125 continues to send a set of Kᵢ packets of the second program P₂ in the plurality of P programs over the multiplicity of Kᵢ channels, respectively. The third modulator 1126 continues to send a set of Kᵢ packets of the third program P₃ in the plurality of P programs over the multiplicity of Kᵢ channels, respectively.

The modulator means may include a multiplicity of Kᵢ modulators, for modulating each packet. Quadrature amplitude modulation (QAM) or other modulation formats may be used. Alternatively, the modulator means may include a single modulator for modulating each packet in a form suitable for transmission over the multiplicity of Kᵢ channels, respectively. The single modulator may be shared among the the multiplicity of Kᵢ channels.

From the multiplicity of Kᵢ channels, first receiver means receives each set of Kᵢ packets of the first program P₁. The first receiver means initiates display of the first program P₁, upon receipt of the first set of Kᵢ packets of the first program P₁. The first receiver means typically would include a first set top box and a first TV receiver 1128. The first set top box and/or first TV receiver 1128 include the necessary electronics and initiates display of the first program P₁ upon receipt of the first set of Kᵢ packets of the first program P₁.

Second receiver means receives, from the multiplicity of Kᵢ channels, each set of Kᵢ packets of the second program P₂. The second receiver means initiates display of the second program P₂ upon receipt of the first set of Kᵢ packets of the second program P₂. The second receiver means typically would include a second set top box and a second TV receiver 1129. The second set top box and/or second TV receiver 1129 include the necessary electronics initiates display of the first program P₂ upon receipt of the first set of Kᵢ packets of the first program P₂.

Similarly, third receiver means receives, from the multiplicity of Kᵢ channels, each set of Kᵢ packets of the third program P₃. The third receiver means initiates display of the third program P₃ upon receipt of the third set of Kᵢ packets of the third program P₃. The third receiver means typically would include a third set top box and a third TV receiver 1130. The third set top box and/or third TV receiver 1130 include the necessary electronics initiates display of the first program P₃ upon receipt of the first set of Kᵢ packets of the first program P₃.

A single program may be sent, with the benefit of increased speed, and reduced delay, to initiate viewing of a program. Additional programs may be sent. For a fourth program, the modulator means sends a fourth set of Kᵢ packets of a fourth program P₄ in the plurality of P programs over the multiplicity of Kᵢ channels, respectively. The modulator means continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, and a set of Kᵢ packets of the fourth program P₃ in the plurality of P programs over the multiplicity of Kᵢ channels, respectively. From the multiplicity of Kᵢ channels, fourth receiver means receives each set of Kᵢ packets of the fourth program P₄, and initiates display of the fourth program P₄ upon receipt of the first set of Kᵢ packets of the fourth program P₄.

For a fifth program, modulator means sends a fifth set of Kᵢ packets of a fifth program P₅ in the plurality of P programs over the multiplicity of Kᵢ channels, respectively. The modulator means continues to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, a set of Kᵢ packets of the fourth program P₄ in the plurality of P programs over the multiplicity of Kᵢ channels, respectively, and a set of Kᵢ packets of the fifth program P₅ in the plurality of P programs over the multiplicity of Kᵢ channels, respectively. Fifth receiver means receives each set of Kᵢ packets of the fifth program P₅, and for initiating display of the fifth program P₅ upon receipt of the first set of Kᵢ packets of the fifth program P₅.

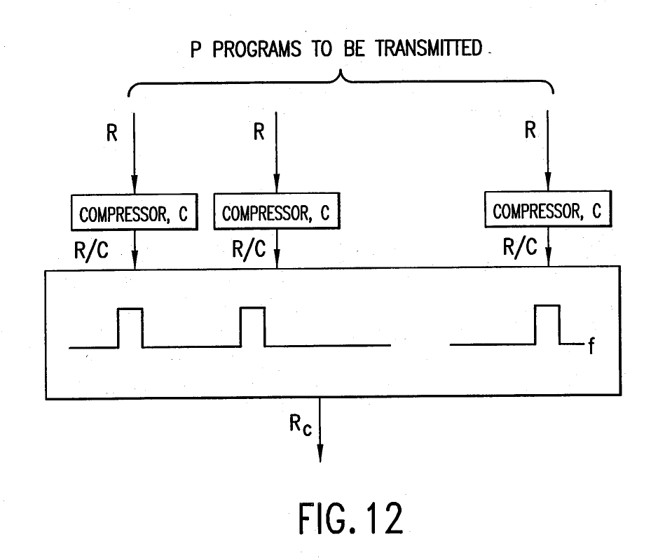

FIG. 12 illustratively shows P programs, which are to be simultaneously streamed to users. Each program is assumed to have, for ease of discussion, the same data rate, R bits/sec. The digital signal is compressed using, as an example, an MPEG compression scheme followed by FEC encoding and modulated as 256 QAM. The result is a total compression factor, C, so that the transmitted information rate is R/C symbols/sec. If a TV channel had a capacity of R_{c} bits/sec, then each program can be filtered and transmitted through a single TV cannel, without delay, provided that:

(PR/C)<R_{c}

This result can be achieved if the number of programs, P, is less than the total compression factor, C, multiplied by the ratio of the channel capacity divided by the program rate:

P<C(R_{c}/R)

If HDTV were employed, R may increase by a factor of four or more, while R_{c} does not change. This further limits the number of programs P that can be simultaneously streamed.

If FDM is employed, no delay exists in programs reception, relative to another program reception. Reception is achieved using standard techniques of filtering each program and then decompressing, by demodulating, FEC decoding, and then using the MPEG decoder.

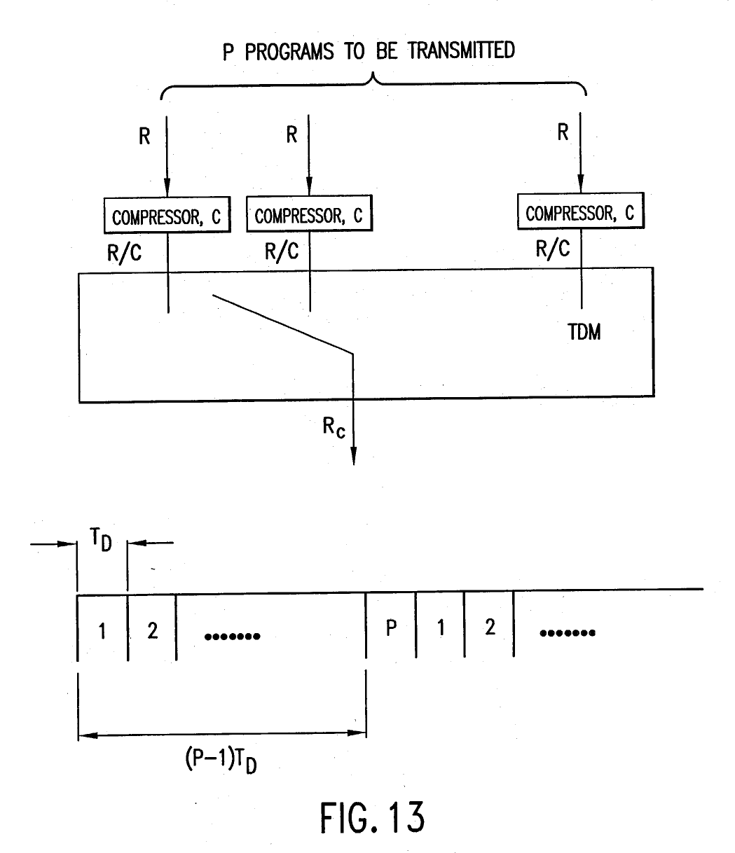

FIG. 13 depicts a system similar to FIG. 12, except that in FIG. 13 the P streaming, compressed, programs are TDM before transmission. Since the capacity of a single video channel is R_{c} bits/sec, the P streamed programs can be transmitted in a single channel if:

P(R/C)<R_{c}

Thus the number of programs must be less than the compression factor, C, multiplied by the ratio of the channel divided by the uncompressed, streaming rate of the program:

P<C(R_{c}/R)

If HDTV were used, R may increase by a factor of four or more. Thus the number of programs that can be streamed simultaneously markedly is decreased.

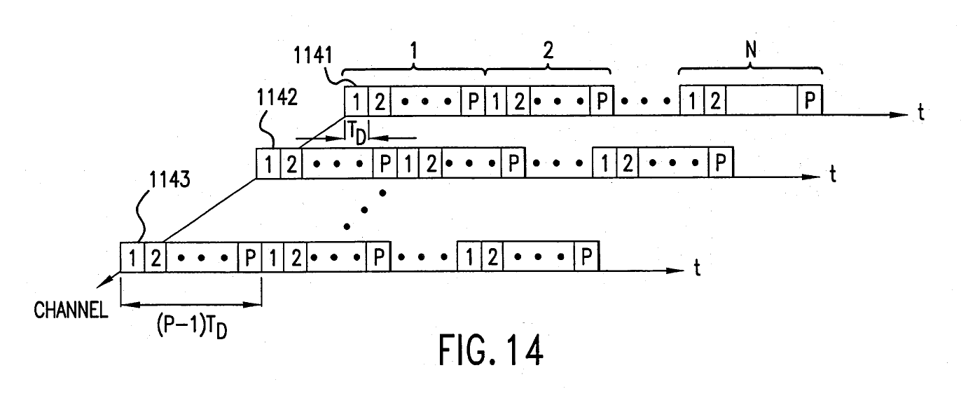

FIG. 14 illustrates a multiplicity of channels, and the time division multiplex (TDM) of the signals. Since TDM is employed, the P^{th} program is delayed relative to the first program sent, by:

DELAY=(P−1)T_{D}

Where T_{D} is the time interval spent. T_{D} is greater than or equal to the time required to send a symbol:

T_{D}≧1/(R/C)

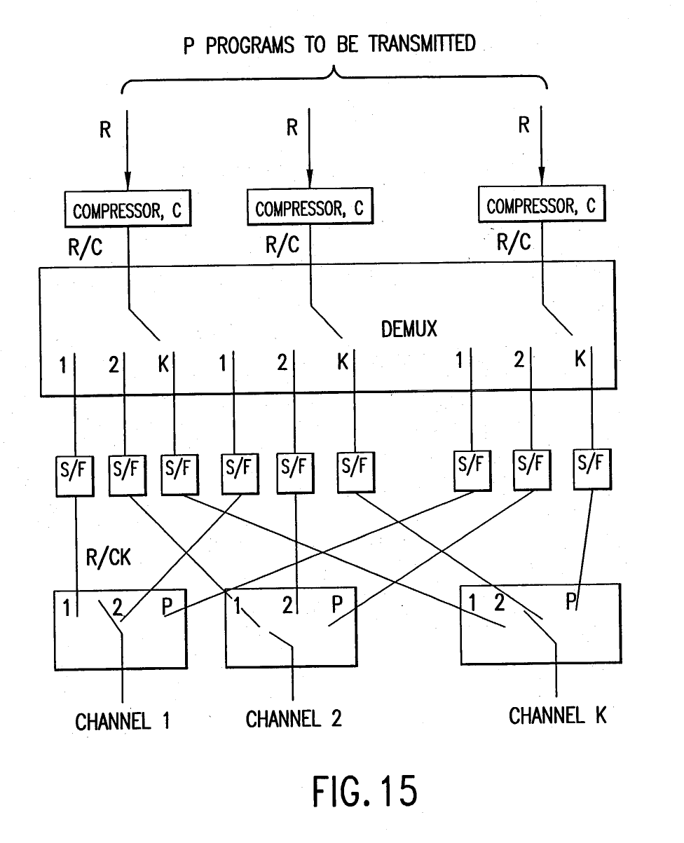

In FIG. 15, the P programs are bursted to the receivers using MCMD. Each program originally is streamed at the rate R bits of information/sec. Using MCMD each program is demultiplexed, bit by bit, into K distinct packets. Each packet contains 1/K of the program. The first program is initially stored and then forwarded over the K available channels. The process is continued until all P programs are sent.

Assuming a channel rate of R_{c}, the program is received after a time duration:

T_{B}=(R/R_{c})(1/CK)Tₚ

Where Tₚ is the duration of a streamed program without MCMD. T_{B} is the burst duration.

Since FDM is employed, there is no delay in program reception. Reception is achieved using standard techniques of filtering each program, and decompressing, demodulating, FEC decoding, and using the MPEG decoder.

Since the second program is bursted after the first program, and the third program after the second program, the P^{th} program is received with a delay:

DELAY=(P−1)T_{B}

This delay can be reduced significantly, using TDM.

Instead of TDM after each program is completed, every time interval, T_{D}, e.g., every 0.2 seconds, a different program is sent over K channels. Thus, for the first T_{D}, packets are sent from the first program, over the K available channels. For the next interval T_{D}, packets are sent from the second program, over the K channels available at that time. This process is continued until all P programs are bursted. If the process were repeated N times, then the delay time experienced by the P^{th} program is reduced significantly and:

DELAY=(P−1)T_{B}/N

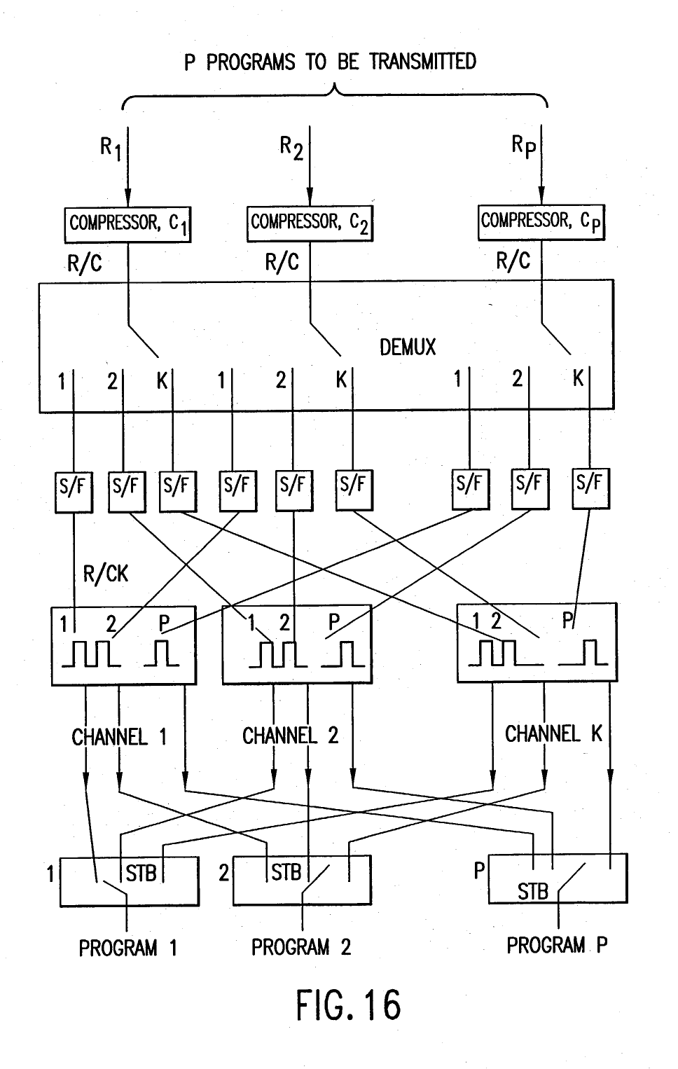

FIG. 16 shows P data streams, representing P VOD programs that are requested at approximately the same time. Each program is packetized. Overhead is inserted, such as header and address. The P packets are multiplexed in the MUX. The resultant data stream is demuxed and modulated on K different, borrowed, frequency channels. The K signals are then transmitted over the cable, wireless, etc., medium.

At the user STB, the K modulated data streams are demodulated, collected, and put into a stream of data by the frequency MUX. The data are then demuxed, where the data are separated into packets. Each packet is depacketized by the user requesting each of the VOD programs.

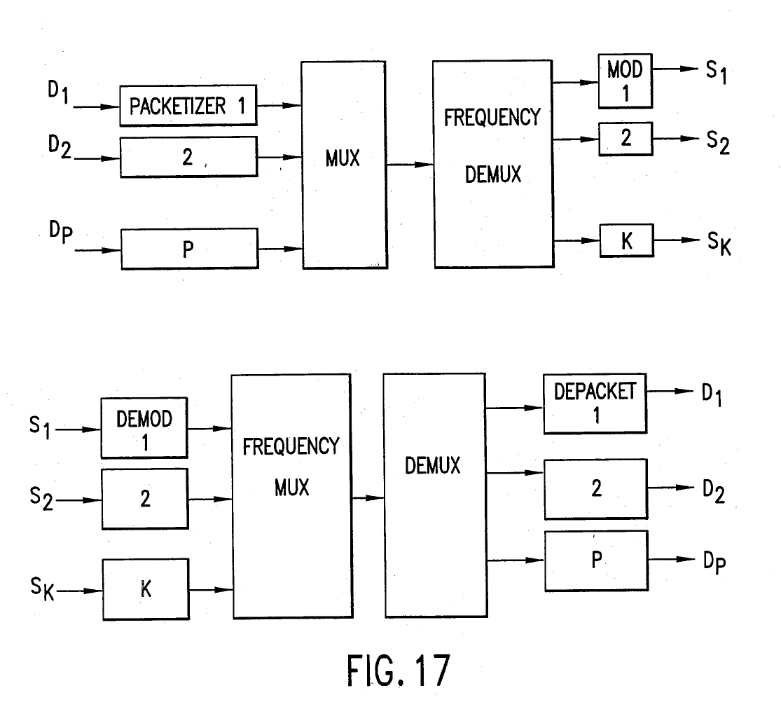

FIG. 17 shows the P programs, each transmitted at the same rate R, which is assumed for ease of explanation, and is compressed by a factor C. The resulting data rate is R/C. This is the same as using a standard compression scheme such as MPEG-2 or MPEG-4, combined with FEC encoding and modulation. A packet from each program is sent over each of K frequencies in succession. The effective rate is R/CK. The P programs are sent, in packet order, over each of the K frequency channels. At a user STB, the requested program is reconstructed.

It will be apparent to those skilled in the art that various modifications can be made to the piracy prevention system and method of the instant invention without departing from the scope or spirit of the invention, and it is intended that the present invention cover modifications and variations of the piracy prevention system and method provided they come within the scope of the appended claims and their equivalents.

I claim:

1. An improvement to a television channel distribution system having a multiplicity of Kᵢ channels, where Kᵢ is a number of available channels and an index i refers to a particular number of Kᵢ channels, for delivering a plurality of P programs, where P is a number of programs, with each program having digitized-compressed content with B_{Tj} bits per program, where B_{T} is a number of bits and an index value of j refers to a particular program Pⱼ in the plurality of P programs, comprising:
pocketing means for generating, for each program Pⱼ in the plurality of P programs, a set of NⱼKᵢ packets, where Nⱼ, for a particular program Pⱼ in the plurality of P programs, is a number of packets per channel in the multiplicity of Kᵢ channels;
modulator means for modulating each packet in a form suitable for transmission over the multiplicity of Kᵢ channels, respectively;
said modulator means for sending a first set of Kᵢ packets of a first program P₁ in the plurality of P programs over the multiplicity of Kᵢ channels, respectively, for sending a second set of Kᵢ packets of a second program P₂ in the plurality of P programs over the multiplicity of Kᵢ channels, respectively, and for sending a third set of Kᵢ packets of a third program P₃ in the plurality of P programs over the multiplicity of Kᵢ channels, respectively;
said modulator means for continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, and a set of Kᵢ packets of the third program P₃ in the plurality of P programs over the multiplicity of Kᵢ channels, respectively;
first receiver means for receiving, from the multiplicity of Kᵢ channels, each set of Kᵢ packets of the first program P₁, and for initiating display of the first program P₁ upon receipt of the first set of Kᵢ packets of the first program P₁;
second receiver means for receiving, from the multiplicity of Kᵢ channels, each set of Kᵢ packets of the second program P₂, and for initiating display of the second program P₂ upon receipt of the first set of Kᵢ packets of the second program P₂; and
third receiver means for receiving, from the multiplicity of Kᵢ channels, each set of Kᵢ packets of the third program P₃, and for initiating display of the third program P₃ upon receipt of the third set of Kᵢ packets of the third program P₃.

2. The improvement as set forth in claim 1, with said modulator means including a multiplicity of Kᵢ modulators, for modulating each packet in a form suitable for transmission over the multiplicity of Kᵢ channels, respectively.

3. The improvement as set forth in claim 2, with said modulator means including a multiplicity of Kᵢ modulators, for modulating each packet in a form using quadrature amplitude modulation and suitable for transmission over the multiplicity of Kᵢ channels, respectively.

4. The improvement as set forth in claim 1, with said modulator means including a modulator for modulating each packet in a form suitable for transmission over the multiplicity of Kᵢ channels, respectively.

5. The improvement as set forth in claim 4, with said modulator for modulating each packet in a form using quadrature amplitude modulation and suitable for transmission over the multiplicity of Kᵢ channels, respectively.

6. The improvement as set forth in claim 1, further including:
said modulator means for sending a fourth set of Kᵢ packets of a fourth program P₄ in the plurality of P programs over the multiplicity of Kᵢ channels, respectively;
said modulator means for continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, and a set of Kᵢ packets of the fourth program P₃ in the plurality of P programs over the multiplicity of Kᵢ channels, respectively;
fourth receiver means for receiving, from the multiplicity of Kᵢ channels, each set of Kᵢ packets of the fourth program P₄, and for initiating display of the fourth program P₄ upon receipt of the first set of Kᵢ packets of the fourth program P₄.

7. The improvement as set forth in claim 6, further including:
said modulator means for sending a fifth set of Kᵢ packets of a fifth program P₅ in the plurality of P programs over the multiplicity of Kᵢ channels, respectively;
said modulator means for continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, a set of Kᵢ packets of the fourth program P₄ in the plurality of P programs over the multiplicity of Kᵢ channels, respectively, and a set of Kᵢ packets of the fifth program P₅ in the plurality of P programs over the multiplicity of Kᵢ channels, respectively;
fifth receiver means for receiving, from the multiplicity of Kᵢ channels, each set of Kᵢ packets of the fifth program P₅, and for initiating display of the fifth program P₅ upon receipt of the first set of Kᵢ packets of the fifth program P₅.

8. An improvement to a television channel distribution method having a multiplicity of Kᵢ channels, where Kᵢ is a number of available channels and an index i refers to a particular number of Kᵢ channels, for delivering a plurality of P programs, where P is a number of programs, with each program having digitized-compressed content with B_{Tj} bits per program, where B_{T} is a number of bits and an index value of j refers to a particular program Pⱼ in the plurality of P programs, comprising the steps of:
generating, for each program Pⱼ in the plurality of P programs, a set of NⱼKᵢ packets, where Nⱼ, for a particular program Pⱼ in the plurality of P programs, is a number of packets per channel in the multiplicity of Kᵢ channels;
modulating each packet in a form suitable for transmission over the multiplicity of Kᵢ channels, respectively;
sending a first set of Kᵢ packets of a first program P₁ in the plurality of P programs over the multiplicity of Kᵢ channels, respectively;
sending a second set of Kᵢ packets of a second program P₂ in the plurality of P programs over the multiplicity of Kᵢ channels, respectively;
sending a third set of Kᵢ packets of a third program P₃ in the plurality of P programs over the multiplicity of Kᵢ channels, respectively;
continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, and a set of Kᵢ packets of the third program P₃ in the plurality of P programs over the multiplicity of Kᵢ channels, respectively;
receiving, from the multiplicity of Kᵢ channels, each set of Kᵢ packets of the first program P₁;
initiating display of the first program P₁ upon receipt of the first set of Kᵢ packets of the first program P₁;
receiving, from the multiplicity of Kᵢ channels, each set of Kᵢ packets of the second program P₂;
initiating display of the second program P₂ upon receipt of the first set of Kᵢ packets of the second program P₂;
receiving, from the multiplicity of Kᵢ channels, each set of Kᵢ packets of the third program P₃; and
initiating display of the third program P₃ upon receipt of the third set of Kᵢ packets of the third program P₃.

9. The improvement as set forth in claim 8, with the step of modulating including the step of modulating each packet in a form using quadrature amplitude modulation and suitable for transmission over the multiplicity of Kᵢ channels, respectively.

10. The improvement as set forth in claim 8, further including the steps of:
sending a fourth set of Kᵢ packets of a fourth program P₄ in the plurality of P programs over the multiplicity of Kᵢ channels, respectively;
continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, and a set of Kᵢ packets of the fourth program P₃ in the plurality of P programs over the multiplicity of Kᵢ channels, respectively;
receiving, from the multiplicity of Kᵢ channels, each set of Kᵢ packets of the fourth program P₄; and
initiating display of the fourth program P₄ upon receipt of the first set of Kᵢ packets of the fourth program P₄.

11. The improvement as set forth in claim 10, further including the steps of:
sending a fifth set of Kᵢ packets of a fifth program P₅ in the plurality of P programs over the multiplicity of Kᵢ channels, respectively;
continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, a set of Kᵢ packets of the fourth program P₄ in the plurality of P programs over the multiplicity of Kᵢ channels, respectively, and a set of Kᵢ packets of the fifth program P₅ in the plurality of P programs over the multiplicity of Kᵢ channels, respectively;
receiving, from the multiplicity of Kᵢ channels, each set of Kᵢ packets of the fifth program P₅; and
initiating display of the fifth program P₅ upon receipt of the first set of Kᵢ packets of the fifth program P₅.

12. An improvement to a television channel distribution system having a multiplicity of Kᵢ channels, where Kᵢ is a number of available channels and an index i refers to a particular number of Kᵢ channels, for delivering a plurality of P programs, where P is a number of programs, with each program having digitized-compressed content with B_{Tj} bits per program, where B_{T} is a number of bits and an index value of j refers to a particular program Pⱼ in the plurality of P programs, comprising:
packeting means for generating, for each program Pⱼ in the plurality of P programs, a set of NⱼKᵢ packets, where Nⱼ, for a particular program Pⱼ in the plurality of P programs, is a number of packets per channel in the multiplicity of Kᵢ channels;
a multiplicity of Kᵢ modulators, for modulating each packet in a form suitable for transmission over the multiplicity of Kᵢ channels, respectively;
said multiplicity of Kᵢ modulators for sending a first set of Kᵢ packets of a first program P₁ in the plurality of P programs over the multiplicity of Kᵢ channels, respectively, for sending a second set of Kᵢ packets of a second program P₂ in the plurality of P programs over the multiplicity of Kᵢ channels, respectively, and for sending a third set of Kᵢ packets of a third program P₃ in the plurality of P programs over the multiplicity of Kᵢ channels, respectively;
said multiplicity of Kᵢ modulators for continuing to send, in sequence, a set of Kᵢ packets of the first program P₁ in the plurality of P programs over the multiplicity of Kᵢ channels, respectively, a set of Kᵢ packets of a second program P₂ in the plurality of P programs over the multiplicity of Kᵢ channels, respectively, and a set of Kᵢ packets of a third program P₃ in the plurality of P programs over the multiplicity of Kᵢ channels, respectively;
a first receiver for receiving, from the multiplicity of Kᵢ channels, each set of Kᵢ packets of the first program P₁, and for initiating display of the first program P₁ upon receipt of the first set of Kᵢ packets of the first program P₁;
a second receiver for receiving, from the multiplicity of Kᵢ channels, each set of Kᵢ packets of the second program P₂, and for initiating display of the second program P₂ upon receipt of the first set of Kᵢ packets of the second program P₂; and
a third receiver for receiving, from the multiplicity of Kᵢ channels, each set of Kᵢ packets of the third program P₃, and for initiating display of the third program P₃ upon receipt of the third set of Kᵢ packets of the third program P₃.

13. The improvement as set forth in claim 12, with said multiplicity of Kᵢ modulators for modulating each packet in a form using quadrature amplitude modulation and suitable for transmission over the multiplicity of Kᵢ channels, respectively.

14. The improvement as set forth in claim 12, further including:
said multiplicity of Kᵢ modulators for sending a fourth set of Kᵢ packets of a fourth program P₄ in the plurality of P programs over the multiplicity of Kᵢ channels, respectively;
said multiplicity of Kᵢ modulators for continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, and a set of Kᵢ packets of the fourth program P₃ in the plurality of P programs over the multiplicity of Kᵢ channels, respectively;
a fourth receiver for receiving, from the multiplicity of Kᵢ channels, each set of Kᵢ packets of the fourth program P₄, and for initiating display of the fourth program P₄ upon receipt of the first set of Kᵢ packets of the fourth program P₄.

15. The improvement as set forth in claim 14, further including:
said multiplicity of Kᵢ modulators for sending a fifth set of Kᵢ packets of a fifth program P₅ in the plurality of P programs over the multiplicity of Kᵢ channels, respectively;
said multiplicity of Kᵢ modulators for continuing to send, in sequence, a set of Kᵢ packets of the first program P₁ in the plurality of P programs over the multiplicity of Kᵢ channels, respectively, a set of Kᵢ packets of the second program P₂ in the plurality of P programs over the multiplicity of Kᵢ channels, respectively, a set of Kᵢ packets of the third program P₃ in the plurality of P programs over the multiplicity of Kᵢ channels, respectively, a set of Kᵢ packets of the fourth program P₄ in the plurality of P programs over the multiplicity of Kᵢ channels, respectively, and a set of Kᵢ packets of the fifth program P₅ in the plurality of P programs over the multiplicity of Kᵢ channels, respectively;
a fifth receiver for receiving, from the multiplicity of Kᵢ channels, each set of Kᵢ packets of the fifth program P₅, and for initiating display of the fifth program P₅ upon receipt of the first set of Kᵢ packets of the fifth program P₅.

16. An improvement to a television channel distribution system having a multiplicity of Kᵢ channels, where Kᵢ is a number of available channels and an index i refers to a particular number of Kᵢ channels, for delivering a programs, with the program having digitized-compressed content with B_{T} bits per program, where B_{T} is a number of bits, comprising:
packeting means for generating, for the program, a set of NⱼKᵢ packets, where Nⱼ, for the particular program, is a number of packets per channel in the multiplicity of Kᵢ channels;
modulator means for modulating each packet in a form suitable for transmission over the multiplicity of Kᵢ channels, respectively;
said modulator means for sending a first set of Kᵢ packets of the program over the multiplicity of Kᵢ channels, respectively;
said modulator means for continuing to send, in sequence, a set of Kᵢ packets of the program over the multiplicity of Kᵢ channels, respectively; and
receiver means for receiving, from the multiplicity of Kᵢ channels, each set of Kᵢ packets of the program, and for initiating display of the program upon receipt of the first set of Kᵢ packets of the program.

17. The improvement as set forth in claim 16, with said modulator means including a multiplicity of Kᵢ modulators, for modulating each packet in a form suitable for transmission over the multiplicity of Kᵢ channels, respectively.

18. The improvement as set forth in claim 17, with said modulator means including a multiplicity of Kᵢ modulators, for modulating each packet in a form using quadrature amplitude modulation and suitable for transmission over the multiplicity of Kᵢ channels, respectively.

19. The improvement as set forth in claim 16, with said modulator means including a modulator for modulating each packet in a form suitable for transmission over the multiplicity of Kᵢ channels, respectively.

20. The improvement as set forth in claim 19, with said modulator for modulating each packet in a form using quadrature amplitude modulation and suitable for transmission over the multiplicity of Kᵢ channels, respectively.

21. An improvement to a television channel distribution method having a multiplicity of Kᵢ channels, where Kᵢ is a number of available channels and an index i refers to a particular number of Kᵢ channels, for delivering a program, with the program having digitized-compressed content with B_{T} bits per program, where B_{T} is a number of bits, comprising the steps of:
generating, for the program, a set of NⱼKᵢ packets, where Nⱼ, for the program, is a number of packets per channel in the multiplicity of Kᵢ channels;
modulating each packet in a form suitable for transmission over the multiplicity of Kᵢ channels, respectively;
sending a first set of Kᵢ packets of the program over the multiplicity of Kᵢ channels, respectively;
continuing to send, in sequence, a set of Kᵢ packets of the program over the multiplicity of Kᵢ channels, respectively;
receiving, from the multiplicity of Kᵢ channels, each set of Kᵢ packets of the program;
initiating display of the program upon receipt of the first set of Kᵢ packets of the program.

22. The improvement as set forth in claim 21, with the step of modulating including the step of modulating each packet in a form using quadrature amplitude modulation and suitable for transmission over the multiplicity of Kᵢ channels, respectively.

23. An improvement to a television channel distribution system having a multiplicity of Kᵢ channels, where Kᵢ is a number of available channels and an index i refers to a particular number of Kᵢ channels, for delivering a program, with the program having digitized-compressed content with B_{T} bits per program, where B_{T} is a number of bits, comprising:
packeting means for generating, for the program, a set of NⱼKᵢ packets, where Nⱼ, for the program, is a number of packets per channel in the multiplicity of Kᵢ channels;
a multiplicity of Kᵢ modulators, for modulating each packet in a form suitable for transmission over the multiplicity of Kᵢ channels, respectively;
said multiplicity of Kᵢ modulators for sending a first set of Kᵢ packets of the program over the multiplicity of Kᵢ channels, respectively;
said multiplicity of Kᵢ modulators for continuing to send, in sequence, a set of Kᵢ packets of the program over the multiplicity of Kᵢ channels, respectively;
a first receiver for receiving, from the multiplicity of Kᵢ channels, each set of Kᵢ packets of the program, and for initiating display of the program P₁ upon receipt of the first set of Kᵢ packets of the program P₁.

24. The improvement as set forth in claim 23, with said multiplicity of Kᵢ modulators for modulating each packet in a form using quadrature amplitude modulation and suitable for transmission over the multiplicity of Kᵢ channels, respectively.

25. The improvement as set for in claim 1, further including means for interleaving the packets with certain packets having different priority than other packets, with the packets having higher priority being sent more frequently.

26. The improvement as set for in claim 12, further including means for interleaving the packets with certain packets having different priority than other packets, with the packets having higher priority being sent more frequently.

27. The improvement as set for in claim 23, further including means for interleaving the packets with certain packets having different priority than other packets, with the packets having higher priority being sent more frequently.

28. The improvement as set for in claim 8, further including the step of interleaving the packets with certain packets having different priority than other packets, with the packets having higher priority being sent more frequently.

29. The improvement as set for in claim 21, further including the step of interleaving the packets with certain packets having different priority than other packets, with the packets having higher priority being sent more frequently.
